(19) United States
(12) Patent Application Publication
(10) Pub. No.: US 2020/0260401 A1
(43) Pub. Date: Aug. 13, 2020

(54) SESSION MANAGEMENT POLICY SUPPORT FOR SESSION ESTABLISHMENT

(71) Applicant: ZTE Corporation, Shenzhen (CN)

(72) Inventor: Tricci So, Oceanside, CA (US)

(21) Appl. No.: 16/274,197

(22) Filed: Feb. 12, 2019

(51) Int. Cl. H04W 60/04; H04W 80/10; H04W 76/50; H04W 60/06; H04W 48/04

(52) U.S. Cl. CPC H04W 60/04; H04W 80/10; H04W 84/042; H04W 60/06; H04W 48/04; H04W 76/50

(57) ABSTRACT

A method of wireless communication includes receiving, by a device in a wireless network, a registration request from the wireless device, initiating, in response to the registration request, a trigger to the serving policy control function of the wireless device for the delivery of a session management related policy information to the wireless device and may be an explicit indication for the expected policy delivery, and sending, after the initiating, to the wireless device, a registration acceptance message that may include the explicit indication indicating to the wireless device that the wireless device has been registered in the wireless network.

### TECHNICAL FIELD

The present document relates to wireless communications.

### BACKGROUND

Mobile communication technologies are moving the world toward an increasingly connected and networked society. The rapid growth of mobile communications and advances in technology have led to greater demand for capacity and connectivity. Other aspects, such as energy consumption, device cost, spectral efficiency, and latency are also important to meeting the needs of various communication scenarios. Various techniques, including new ways to provide higher quality of service, longer battery life, and improved performance are being discussed.

### SUMMARY

The present document describes techniques that can be used to improve operation of wireless networks.

In one example aspect, a method of wireless communication is disclosed. The method includes receiving, by a device in a wireless network, a registration request from the wireless device, initiating, in response to the registration request, a trigger to the serving policy control function of the wireless device for the delivery of a session management related policy information to the wireless device, and sending, after the initiating, to the wireless device, a registration acceptance message indicating to the wireless device that the wireless device has been registered in the wireless network.

In another example aspect, another method of wireless communication is disclosed. The method includes transmitting, by a wireless device, a registration request to a network node in a wireless network, initiating, in response to the registration request, a trigger to the serving policy control function of the wireless device for the delivery of a session management related policy information to the wireless device and also an explicit indication for the expected policy delivery, and sending, after the initiating, to the wireless device, a registration acceptance message with the explicit policy indication to the wireless device that the wireless device has been registered in the wireless network.

In yet another aspect, one or more of the above-described methods may be implemented by a wireless communications apparatus that includes a processor.

In yet another aspect, the above-described methods may be embodied as processor-executable code and stored on a computer readable medium.

These, and other, features are described in the present document.

### LISTING OF DRAWINGS

FIG. 1A illustrates an example of messages exchanged during registration of a user device.

FIG. 1B illustrates an example of messages exchanged during registration of a user device.

FIG. 2 shows an example message format.

FIG. 3 shows a flowchart for a wireless communication method.

FIG. 4 shows a flowchart for another wireless communication method.

FIG. 5 is a block diagram showing an example of a wireless communication system.

FIG. 6 is a block diagram of an example embodiment of a wireless communication device.

### DETAILED DESCRIPTION

Section headers are used in the Detailed Description section to facilitate ease of understanding and do not limit the use of the disclosed technologies and embodiments in any section only to that section. Furthermore, while certain concepts and embodiments have been explained using 5G nomenclature, the techniques and embodiments are not limited to 5G systems and devices only and may be used in other communication networks that use different protocols.

Brief Discussion

Today 3GPP Release-15, the UE selects the access type (i.e. 3GPP or non-3GPP) to transport the traffic for the target service application (e.g. VoIP, NetFlix etc.) in a PDU session based on the policy rule obtained from the Policy Control Function (PCF), if provided, and such policy rule is part of the UE Route Selection Policy (URSP) rules. Otherwise, the UE selects the access type for the target service application based on its pre-configured local policy. In Release 15, the support for URSP is optional. Furthermore, the UE Configuration Update procedure to update UE with the URSP rules is an independent operation and is operator's local implementation decision to determine for when to send the URSP to the UE. Therefore, in 3GPP Release-15, the UE may not have sufficient access policy information for PDU session establishment until it obtains the URSP rules from its serving PCF in home PLMN regardless roaming or non-roaming scenario.

In a 5G system, a PDU session is defined as an association between the UE and a Data Network that provides a PDU connectivity service. The traffic type of a PDU Session can be IPv4, IPv6, IPv4v6, Ethernet or Unstructured data traffic. In 3GPP Release-16 which is the phase-2 development of the 3GPP 5G system, a new type of PDU session is introduced to support Multi-access Traffic Steering, Switching and Splitting (ATSSS) which enables the UE and the 5GC to cooperatively control the steering, switching and splitting traffic across the 3GPP and non-3GPP access (e.g. Wifi access). When initiating a PDU session to support the ATSSS, the “common” PDU session is transported over either on the single access (i.e. 3GPP or non-3GPP access) or on both accesses concurrently, such type of PDU session is referred as Multi-Access PDU (MA-PDU) session. In summary, the UE may initiate either the single access PDU (SA-PDU) session or MA-PDU session starting in Release-16.

In 3GPP Release-16, the ATSSS capable UE has the option to initiate either the SA-PDU session (not for the purpose of ATSSS) or MA-PDU session (for the purpose of ATSSS) for the target service application. The UE initiation for which type of PDU session is based on either the URSP rule, if provided by the UE's serving PCF in home PLMN, or based on the pre-configured local policy within the UE. When ATSSS capable UE registers the first time with the Release 16 ATSSS capable 5GC, it is possible that, the UE has not yet received any URSP rule (i.e. the Policy Selection Identifier (PSI) is empty). Given the URSP rule is optional and even if it is available to the UE, it is operator's local implementation decision to determine for when to send the URSP rule to the UE. As a result, the newly registered ATSSS capable UE would not know whether it should wait for the URSP rule or just simply to apply its local policy to initiate the PDU session for the given application. If UE initiates the PDU session before receiving the URSP rule from the PCF, it could end up with the wrong type of PDU session for the given service application. Furthermore, according to 3GPP Release 15 TS 23.502 specification for the URSP implementation, once the PDU Session has established and then the UE receives the URSP rule, the UE shall examine the URSP rule within the UE Policy in order to determine whether the existing PDU Session is maintained or not. If not, then the UE may initiate a PDU Session release procedure for the PDU Session(s) that cannot be maintained.

Therefore, in order to ensure the proper policy enforcement for the PDU session establishment, there is a need to inform the UE, if any, of the upcoming URSP rule configuration update from UE's serving PCF in the home PLMN in advance before the UE to initiate the proper PDU session to support the target service application invoked by the UE.

This patent document relates to, among other things, a method to define a core network solution to ensure the accurate policy control from the 5G core network (5GC) to the 3GPP mobile device (i.e. UE) when the UE initiates the establishment for a Single-access PDU (SA-PDU) session or Multi-access PDU (MA-PDU) session for a given service application (e.g. VoIP, NetFlix etc.) after the UE registers with the 3GPP 5G system. Given the UE may have not received any network policy for the session management information corresponding to the type of PDU session for the target service application prior to the PDU session establishment, it is important to assist the UE to obtain the proper session management policy before initiating the establishment for the particular type of PDU session.

Example Principles

The proposed solution in this patent document considers that there may or may not be any URSP rule provisioned for the UE in the home PLMN, and hence, the solution needs to ensure a deterministic behaviour in the UE to support the initiation of a PDU session establishment for the target service application. Furthermore, there could be high volume of URSP rules to be provided to the UE, hence, it is important not to overload the response to the request of the UE Registration (i.e. the Registration Accept message) to provide the URSP rules to the UE.

Solution Summary

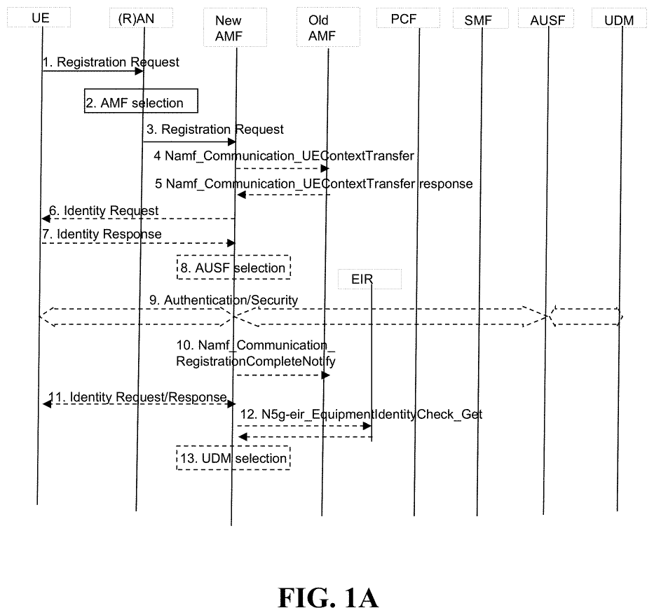

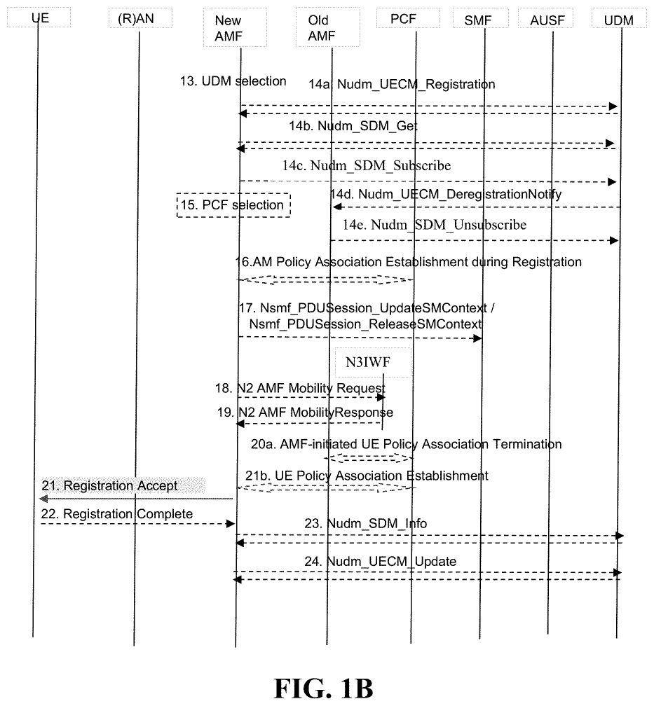

Based on the above design considerations, this patent document proposes a new network indication in Release 16 5GC, referred as “URSP Indication” to be included in Registration Accept message which is sent by the UE's serving Access and Mobility Management Function (AMF) to the UE. The URSP Indication is used to indicate that there is URSP rules to be provided by the UE's serving PCF from the UE's home PLMN to the UE to support access selection and for PDU Session related policy. In order to support this new URSP Indication, this patent document discloses changes to the UE Registration procedures with the 3GPP 5GC as described in clause 4.2.2.2.2 in 3GPP TS 23.502, more specifically, to the two operations—UE Policy Association Establishment and Registration Accept. The most recent version of 3GPP TS 23.501 document illustrated in FIGS. 1A-1B.

Overview of an Example of Registration Process (3GPP TS 23.502)

FIGS. 1A-1B depict an example registration process as follows (note that the order of steps 21 and 21b as described below and depicted in FIG. 1B is swapped in comparison with 3GPP TS 23.502).

Step 1. UE to (R)AN: AN message (AN parameters, Registration Request (Registration type, SUCI or 5G-GUTI or PEI, last visited TAI (if available), Security parameters, Requested NSSAI, [Mapping Of Requested NSSAI], Default Configured NSSAI Indication, UE Radio Capability Update, UE MM Core Network Capability, PDU Session status, List Of PDU Sessions To Be Activated, Follow-on request, MICO mode preference, Requested DRX parameters, [LADN DNN(s) or Indicator Of Requesting LADN Information]) and UE Policy Container (the list of PSIs, indication of UE support for ANDSP and the operating system identifier)).

In the case of NG-RAN, the AN parameters include e.g. 5G-S-TMSI or GUAMI, the Selected PLMN ID and Requested NSSAI, the AN parameters also include Establishment cause. The Establishment cause provides the reason for requesting the establishment of an RRC connection.

The Registration type indicates if the UE wants to perform an Initial Registration (i.e. the UE is in RM-DEREGISTERED state), a Mobility Registration Update (i.e. the UE is in RM-REGISTERED state and initiates a Registration procedure due to mobility or due to the UE needs to update its capabilities or protocol parameters, or to request a change of the set of network slices it is allowed to use), a Periodic Registration Update (i.e. the UE is in RM-REGISTERED state and initiates a Registration procedure due to the Periodic Registration Update timer expiry, see clause 4.2.2.2.1) or an Emergency Registration (i.e. the UE is in limited service state).

When the UE is performing an Initial Registration the UE shall indicate its UE identity in the Registration Request message as follows, listed in decreasing order of preference:

If the UE was previously registered in EPS and has a valid EPS GUTI, the UE provides 5G-GUTI as explained in step 2 of clause 4.11.1.3.3 step 2a.

a native 5G-GUTI assigned by the which the UE is attempting to register, if available;

a native 5G-GUTI assigned by an equivalent PLMN to the PLMN to which the UE is attempting to register, if available;

a native 5G-GUTI assigned by any other PLMN, if available.

NOTE 1: This can also be a 5G-GUTIs assigned via another access type.

Otherwise, the UE shall include its SUCI in the Registration Request as defined in TS 33.501 [15].

If the UE has a NAS security context, as defined in TS 24.501 [25] the UE includes in the Security parameters an indication that the NAS message is integrity protected and partially ciphered to indicate to the AMF how to process the enclosed parameters.

If the UE has no NAS security context, the Registration Request message shall only contain the cleartext IEs as defined in TS 24.501 [25].

When the UE is performing an Initial Registration (i.e., the UE is in RM-DEREGISTERED state) with a native 5G-GUTI then the UE shall indicate the related GUAMI information in the AN parameters. When the UE is performing an Initial Registration with its SUCI, the UE shall not indicate any GUAMI information in the AN parameters.

For an Emergency Registration, the SUCI shall be included if the UE does not have a valid 5G-GUTI available; the PEI shall be included when the UE has no SUPI and no valid 5G-GUTI. In other cases, the 5G-GUTI is included and it indicates the last serving AMF.

The UE may provide the UE's usage setting based on its configuration as defined in TS 23.501 [2] clause 5.16.3.7. In case of Initial Registration or Mobility Registration Update, the UE includes the Mapping Of Requested NSSAI (if available), which is the mapping of each S-NSSAI of the Requested NSSAI to the HPLMN S-NSSAIs, to ensure that the network is able to verify whether the S-NSSAI(s) in the Requested NSSAI are permitted based on the Subscribed S-NSSAIs.

The UE includes the Default Configured NSSAI Indication if the UE is using a Default Configured NSSAI, as defined in TS 23.501 [2].

In the case of Mobility Registration Update, the UE includes in the List Of PDU Sessions To Be Activated the PDU Sessions for which there are pending uplink data. When the UE includes the List Of PDU Sessions To Be Activated, the UE shall indicate PDU Sessions only associated with the access the Registration Request is related to. As defined in TS 24.501 [25] the UE shall include always-on PDU Sessions which are accepted by the network in the List Of PDU Sessions To Be Activated even if there are no pending uplink data for those PDU Sessions.

NOTE 2: A PDU Session corresponding to a LADN is not included in the List Of PDU Sessions To Be Activated when the UE is outside the area of availability of the LADN.

The UE MM Core Network Capability is provided by the UE and handled by AMF as defined in TS 23.501 [2] clause 5.4.4a The UE includes in the UE MM Core Network Capability an indication if it supports Request Type flag “handover” for PDN connectivity request during the attach procedure as defined in clause 5.17.2.3.1 of TS 23.501 [2].

The UE may provide either the LADN DNN(s) or an Indication Of Requesting LADN Information as described in TS 23.501 [2] clause 5.6.5.

If available, the last visited TAI shall be included in order to help the AMF produce Registration Area for the UE.

The Security parameters are used for Authentication and integrity protection, see TS 33.501 [15]. Requested NSSAI indicates the Network Slice Selection Assistance Information (as defined in clause 5.15 of TS 23.501 [2]). The PDU Session status indicates the previously established PDU Sessions in the UE. When the UE is connected to the two AMFs belonging to different PLMN via 3GPP access and non-3GPP access then the PDU Session status indicates the established PDU Session of the current PLMN in the UE.

The Follow-on request is included when the UE has pending uplink signalling and the UE doesn't include List Of PDU Sessions To Be Activated, or the Registration type indicates the UE wants to perform an Emergency Registration. In Initial Registration and Mobility Registration Update, UE provides the UE Requested DRX parameters, as defined in clause 5.4.5 of TS 23.501 [2].

The UE provides UE Radio Capability Update indication as described in TS 23.501 [2].

The UE access selection and PDU session selection identifies the list of UE access selection and PDU session selection policy information stored in the UE, defined in clause 6.6 of TS 23.503 [20]. They are used by the PCF to determine if the UE has to be updated with new PSIs or if some of the stored ones are no longer applicable and have to be removed.

Step 2. If a 5G-S-TMSI or GUAMI is not included or the 5G-S-TMSI or GUAMI does not indicate a valid AMF the (R)AN, based on (R)AT and Requested NSSAI, if available, selects an AMF

The (R)AN selects an AMF as described in TS 23.501 [2], clause 6.3.5. If UE is in CM-CONNECTED state, the (R)AN can forward the Registration Request message to the AMF based on the N2 connection of the UE.

If the (R)AN cannot select an appropriate AMF, it forwards the Registration Request to an AMF which has been configured, in (R)AN, to perform AMF selection.

Step 3. (R)AN to new AMF: N2 message (N2 parameters, Registration Request (as described in step 1) and UE Policy Container.

When NG-RAN is used, the N2 parameters include the Selected PLMN ID, Location Information and Cell Identity related to the cell in which the UE is camping, UE Context Request which indicates that a UE context including security information needs to be setup at the NG-RAN.

When NG-RAN is used, the N2 parameters also include the Establishment cause.

Mapping Of Requested NSSAI is provided only if available.

If the Registration type indicated by the UE is Periodic Registration Update, then steps 4 to 19 may be omitted.

When the Establishment cause is associated with priority services (e.g. MPS, MCS), the AMF includes a Message Priority header to indicate priority information. Other NFs relay the priority information by including the Message Priority header in service-based interfaces, as specified in TS 29.500 [17].

Step 4. [Conditional] new AMF to old AMF: Namf_Communication_UEContextTransfer (complete Registration Request) or new AMF to UDSF: Nudsf_Unstructured Data Management_Query( )

(With UDSF Deployment): If the UE's 5G-GUTI was included in the Registration Request and the serving AMF has changed since last Registration procedure, new AMF and old AMF are in the same AMF Set and UDSF is deployed, the new AMF retrieves the stored UE's SUPI and UE context directly from the UDSF using Nudsf_UnstructuredDataManagement_Query service operation or they can share stored UE context via implementation specific means if UDSF is not deployed. This includes also event subscription information by each NF consumer for the given UE. In this case, the new AMF uses integrity protected complete Registration request NAS message to perform and verify integrity protection.

(Without UDSF Deployment): If the UE's 5G-GUTI was included in the Registration Request and the serving AMF has changed since last Registration procedure, the new AMF may invoke the Namf_Communication_UEContextTransfer service operation on the old AMF including the complete Registration Request NAS message, which may be integrity protected, as well as the Access Type, to request the UE's SUPI and UE Context. See clause 5.2.2.2.2 for details of this service operation. In this case, the old AMF uses either 5G-GUTI and the integrity protected complete Registration request NAS message, or the SUPI and an indication that the UE is validated from the new AMF, to verify integrity protection if the context transfer service operation invocation corresponds to the UE requested. The old AMF also transfers the event subscriptions information by each NF consumer, for the UE, to the new AMF.

If the old AMF has PDU Sessions for another access type (different from the Access Type indicated in this step) and if the old AMF determines that there is no possibility for relocating the N2 interface to the new AMF, the old AMF returns UE's SUPI and indicates that the Registration Request has been validated for integrity protection, but does not include the rest of the UE context.

NOTE 3: The new AMF sets the indication that the UE is validated according to step 9a, in case the new AMF has performed successful UE authentication after previous integrity check failure in the old AMF.

NOTE 4: The NF consumers does not need to subscribe for the events once again with the new AMF after the UE is successfully registered with the new AMF.

If the new AMF has already received UE contexts from the old AMF during handover procedure, then step 4,5 and 10 shall be skipped.

For an Emergency Registration, if the UE identifies itself with a 5G-GUTI that is not known to the AMF, steps 4 and 5 are skipped and the AMF immediately requests the SUPI from the UE. If the UE identifies itself with PEI, the SUPI request shall be skipped. Allowing Emergency Registration without a user identity is dependent on local regulations.

Step 5. [Conditional] old AMF to new AMF: Response to Namf_Communication_UEContextTransfer (SUPI, UE Context in AMF (as per Table 5.2.2.2.2-1)) or UDSF to new AMF: Nudsf_Unstructured Data Management_Query( ) The old AMF may start an implementation specific (guard) timer for the UE context.

If the UDSF was queried in step 4, the UDSF responds to the new AMF for the Nudsf_Unstructured Data Management_Query invocation with the related contexts including established PDU Sessions, the old AMF includes SMF information DNN, S-NSSAI(s) and PDU Session ID, active NGAP UE-TNLA bindings to N3IWF, the old AMF includes information about the NGAP UE-TNLA bindings. If the Old AMF was queried in step 4, Old AMF responds to the new AMF for the Namf_Communication_UEContextTransfer invocation by including the UE's SUPI and UE Context.

If old AMF holds information about established PDU Session(s), the old AMF includes SMF information, DNN(s), S-NSSAI(s) and PDU Session ID(s).

If old AMF holds information about active NGAP UE-TNLA bindings to N3IWF, the old AMF includes information about the NGAP UE-TNLA bindings.

If old AMF fails the integrity check of the Registration Request NAS message, the old AMF shall indicate the integrity check failure.

If old AMF holds information about AM Policy Association, the old AMF includes the information about the AM Policy Association including the policy control request trigger and PCF ID. In the roaming case, V-PCF ID and H-PCF ID are included.

NOTE 5: When new AMF uses UDSF for context retrieval, interactions between old AMF, new AMF and UDSF due to UE signaling on old AMF at the same time is implementation issue.

Step 6. [Conditional] new AMF to UE: Identity Request( ).

If the SUCI is not provided by the UE nor retrieved from the old AMF the Identity Request procedure is initiated by AMF sending an Identity Request message to the UE requesting the SUCI.

Step 7. [Conditional] UE to new AMF: Identity Response( ).

The UE responds with an Identity Response message including the SUCI. The UE derives the SUCI by using the provisioned public key of the HPLMN, as specified in TS 33.501 [15].

Step 8. The AMF may decide to initiate UE authentication by invoking an AUSF. In that case, the AMF selects an AUSF based on SUPI or SUCI, as described in TS 23.501 [2], clause 6.3.4.

If the AMF is configured to support Emergency Registration for unauthenticated SUPIs and the UE indicated Registration type Emergency Registration, the AMF skips the authentication or the AMF accepts that the authentication may fail and continues the Registration procedure.

Step 9a. If authentication is required, the AMF requests it from the AUSF; if Tracing Requirements about the UE are available at the AMF, the AMF provides Tracing Requirements in its request to AUSF. Upon request from the AMF, the AUSF shall execute authentication of the UE. The authentication is performed as described in TS 33.501 [15]. The AUSF selects a UDM as described in TS 23.501 [2], clause 6.3.8 and gets the authentication data from UDM.

Once the UE has been authenticated the AUSF provides relevant security related information to the AMF. In case the AMF provided a SUCI to AUSF, the AUSF shall return the SUPI to AMF only after the authentication is successful.

After successful authentication in new AMF, which is triggered by the integrity check failure in old AMF at step 5, the new AMF invokes step 4 above again and indicates that the UE is validated (i.e. through the reason parameter as specified in clause 5.2.2.2.2).

Step 9b. If NAS security context does not exist, the NAS security initiation is performed as described in TS 33.501 [15]. If the UE had no NAS security context in step 1, the UE includes the full Registration Request message as defined in TS 24.501 [25].

The AMF decides if the Registration Request needs to be rerouted as described in clause 4.2.2.2.3, where the initial AMF refers to the AMF.

Step 9c. The AMF initiates NGAP procedure to provide the 5G-AN with security context as specified in TS 38.413 [10] if the 5G-AN had requested for UE Context. In addition, if Tracing Requirements about the UE are available at the AMF, the AMF provides the 5G-AN with Tracing Requirements in the NGAP procedure.

Step 9d. The 5G-AN stores the security context and acknowledges to the AMF. The 5G-AN uses the security context to protect the messages exchanged with the UE as described in TS 33.501 [15].

Step 10. [Conditional] new AMF to old AMF: Namf_Communication_RegistrationCompleteNotify ( ).

If the AMF has changed the new AMF notifies the old AMF that the registration of the UE in the new AMF is completed by invoking the Namf_Communication_RegistrationCompleteNotify service operation.

If the authentication/security procedure fails, then the Registration shall be rejected, and the new AMF invokes the Namf_Communication_RegistrationCompleteNotify service operation with a reject indication reason code towards the old AMF. The old AMF continues as if the UE context transfer service operation was never received.

If one or more of the S-NSSAIs used in the old Registration Area cannot be served in the target Registration Area, the new AMF determines which PDU Session cannot be supported in the new Registration Area. The new AMF invokes the Namf_Communication_RegistrationCompleteNotify service operation including the rejected PDU Session ID and a reject cause (e.g. the S-NSSAI becomes no longer available) towards the old AMF. Then the new AMF modifies the PDU Session Status correspondingly. The old AMF informs the corresponding SMF(s) to locally release the UE's SM context by invoking the Nsmf_PDUSession_ReleaseSMContext service operation.

See clause 5.2.2.2.3 for details of Namf_Communication_RegistrationCompleteNotify service operation.

If new AMF received in the UE context transfer in step 2 the information about the AM Policy Association including the PCF ID(s) and decides, based on local policies, not to use the PCF(s) identified by the PCF ID(s) for the AM Policy Association, then it will inform the old AMF that the AM Policy Association in the UE context is not used any longer and then the PCF selection is performed in step 15.

Step 11. [Conditional] new AMF to UE: Identity Request/Response (PEI).

If the PEI was not provided by the UE nor retrieved from the old AMF the Identity Request procedure is initiated by AMF sending an Identity Request message to the UE to retrieve the PEI. The PEI shall be transferred encrypted unless the UE performs Emergency Registration and cannot be authenticated.

For an Emergency Registration, the UE may have included the PEI in the Registration Request. If so, the PEI retrieval is skipped.

Step 12. Optionally the new AMF initiates ME identity check by invoking the N5g-eir_EquipmentIdentityCheck_Get service operation (see clause 5.2.4.2.2).

The PEI check is performed as described in clause 4.7.

For an Emergency Registration, if the PEI is blocked, operator policies determine whether the Emergency Registration procedure continues or is stopped.

Step 13. If step 14 is to be performed, the new AMF, based on the SUPI, selects a UDM, then UDM may select a UDR instance. See TS 23.501 [2], clause 6.3.9.

The AMF selects a UDM as described in TS 23.501 [2], clause 6.3.8.

Step 14a-c. If the AMF has changed since the last Registration procedure, or if the UE provides a SUPI which doesn't refer to a valid context in the AMF, or if the UE registers to the same AMF it has already registered to a non-3GPP access (i.e. the UE is registered over a non-3GPP access and initiates this Registration procedure to add a 3GPP access), the new AMF registers with the UDM using Nudm_UECM_Registration for the access to be registered (and subscribes to be notified when the UDM deregisters this AMF).

The AMF provides the “Homogenous Support of IMS Voice over PS Sessions” indication (see clause 5.16.3.3 of TS 23.501 [2]) to the UDM. The “Homogenous Support of IMS Voice over PS Sessions” indication shall not be included unless the AMF has completed its evaluation of the support of “IMS Voice over PS Session” as specified in clause 5.16.3.2 of TS 23.501 [2].

NOTE 6: At this step, the AMF may not have all the information needed to determine the setting of the IMS Voice over PS Session Supported indication for this UE (see clause 5.16.3.2 of TS 23.501 [2]). Hence the AMF can send the “Homogenous Support of IMS Voice over PS Sessions” later on in this procedure.

If the AMF does not have subscription data for the UE, the AMF retrieves the Access and Mobility Subscription data, SMF Selection Subscription data and UE context in SMF data using Nudm_SDM_Get. This requires that UDM may retrieve this information from UDR by Nudr_DM_Query. After a successful response is received, the AMF subscribes to be notified using Nudm_SDM_Subscribe when the data requested is modified, UDM may subscribe to UDR by Nudr_DM_Subscribe. The GPSI is provided to the AMF in the Access and Mobility Subscription data from the UDM if the GPSI is available in the UE subscription data. The UDM may provide indication that the subscription data for network slicing is updated for the UE. If the UE is subscribed to MPS in the serving PLMN, “MPS priority” is included in the Access and Mobility Subscription data provided to the AMF. If the UE is subscribed to MCX in the serving PLMN, “MCX priority” is included in the Access and Mobility Subscription data provided to the AMF.

The new AMF provides the Access Type it serves for the UE to the UDM and the Access Type is set to “3GPP access”. The UDM stores the associated Access Type together with the serving AMF and does not remove the AMF identity associated to the other Access Type if any. The UDM may store in UDR information provided at the AMF registration by Nudr_DM_Update.

If the UE was registered in the old AMF for an access, and the old and the new AMFs are in the same PLMN, the new AMF sends a separate/independent Nudm_UECM_Registration to update UDM with Access Type set to access used in the old AMF, after the old AMF relocation is successfully completed.

The new AMF creates an UE context for the UE after getting the Access and Mobility Subscription data from the UDM. The Access and Mobility Subscription data includes whether the UE is allowed to include NSSAI in the 3GPP access RRC Connection Establishment in clear text.

For an Emergency Registration in which the UE was not successfully authenticated, the AMF shall not register with the UDM.

For an Emergency Registration, the AMF shall not check for access restrictions, regional restrictions or subscription restrictions. For an Emergency Registration, the AMF shall ignore any unsuccessful registration response from UDM and continue with the Registration procedure.

Step 14d. When the UDM stores the associated Access Type (e.g. 3GPP) together with the serving AMF as indicated in step 14a, it will cause the UDM to initiate a Nudm_UECM_DeregistrationNotification (see clause 5.2.3.2.2) to the old AMF corresponding to the same (e.g. 3GPP) access, if one exists. If the timer started in step 5 is not running, the old AMF may remove the UE context. Otherwise, the AMF may remove UE context when the timer expires. If the serving NF removal reason indicated by the UDM is Initial Registration, then, as described in clause 4.2.2.3.2, the old AMF invokes the Nsmf_PDUSession_ReleaseSMContext (SUPI, PDU Session ID) service operation towards all the associated SMF(s) of the UE to notify that the UE is deregistered from old AMF. The SMF(s) shall release the PDU Session on getting this notification.

If the old AMF has established a Policy Association with the PCF, and the old AMF did not transfer the PCF ID(s) to the new AMF (e.g. new AMF is in different PLMN), the old AMF performs an AMF-initiated Policy Association Termination procedure, as defined in clause 4.16.3.2, to delete the association with the PCF. In addition, if the old AMF transferred the PCF ID(s) in the UE context but the new AMF informed in step 10 that the AM Policy Association information in the UE context will not be used then the old AMF performs an AMF-initiated Policy Association Termination procedure, as defined in clause 4.16.3.2, to delete the association with the PCF.

If the old AMF has an N2 connection for that UE (e.g. because the UE was in RRC Inactive state but has now moved to E-UTRAN or moved to an area not served by the old AMF), the old AMF shall perform AN Release (see clause 4.2.6) with a cause value that indicates that the UE has already locally released the NG-RAN's RRC Connection.

Step 14e. The Old AMF unsubscribes with the UDM for subscription data using Nudm_SDM_unsubscribe.

Step 15. If the AMF decides to initiate PCF communication, the AMF acts as follows.

If the new AMF decided to contact the (V-)PCF identified by PCF ID included in UE context from the old AMF in step 5, the AMF contacts the (V-)PCF identified by the (V-)PCF ID. If the AMF decides to perform PCF discovery and selection and the AMF selects a (V)-PCF and may select an H-PCF (for roaming scenario) as described in TS 23.501 [2], clause 6.3.7.1 and according to the V-NRF to H-NRF interaction described in clause 4.3.2.2.3.3.

Step 16. [Optional] new AMF performs an AM Policy Association Modification as defined in clause 4.16.2.1.2. For an Emergency Registration, this step is skipped.

If the new AMF contacts the PCF identified by the (V-)PCF ID received during inter-AMF mobility in step 5, the new AMF shall include the PCF ID(s) in the Npcf_AMPolicyControl Create operation. This indication is not included by the AMF during initial registration procedure.

If the AMF notifies the Mobility Restrictions (e.g. UE location) to the PCF for adjustment, or if the PCF updates the Mobility Restrictions itself due to some conditions (e.g. application in use, time and date), the PCF shall provide the updated Mobility Restrictions to the AMF. If the subscription information includes Tracing Requirements, the AMF provides the PCF with Tracing Requirements.

Step 17. [Conditional] AMF to SMF: Nsmf_PDUSession_UpdateSMContext( ).

For an Emergency Registered UE (see TS 23.501 [2]), this step is applied when the Registration Type is Mobility Registration Update.

The AMF invokes the Nsmf_PDUSession_UpdateSMContext (see clause 5.2.8.2.6) in the following scenario(s):

If the List Of PDU Sessions To Be Activated is included in the Registration Request in step 1, the AMF sends Nsmf_PDUSession_UpdateSMContext Request to SMF(s) associated with the PDU Session(s) in order to activate User Plane connections of these PDU Session(s). Steps from step 5 onwards described in clause 4.2.3.2 are executed to complete the User Plane connection activation without sending the RRC Inactive Assistance Information and without sending MM NAS Service Accept from the AMF to (R)AN described in step 12 of clause 4.2.3.2.

When the serving AMF has changed, the new serving AMF notifies the SMF for each PDU Session that it has taken over the responsibility of the signalling path towards the UE: the new serving AMF invokes the Nsmf_PDUSession_UpdateSMContext service operation using SMF information received from the old AMF at step 5. It also indicates whether the PDU Session is to be re-activated. In the case of PLMN change from V-PLMN to H-PLMN, the new serving AMF only invokes the Nsmf_PDUSession_UpdateSMContext service operation for Home Routed PDU session(s).

NOTE 7: If the UE moves into a V-PLMN, the AMF in the V-PLMN can not insert or change the V-SMF(s) even for Home Routed PDU session(s).

Steps from step 5 onwards described in clause 4.2.3.2 are executed. In the case that the intermediate UPF insertion, removal, or change is performed for the PDU Session(s) not included in “PDU Session(s) to be re-activated”, the procedure is performed without N11 and N2 interactions to update the N3 user plane between (R)AN and 5GC.

The AMF invokes the Nsmf_PDUSession_ReleaseSMContext service operation towards the SMF in the following scenario:

If any PDU Session status indicates that it is released at the UE, the AMF invokes the Nsmf_PDUSession_ReleaseSMContext service operation towards the SMF in order to release any network resources related to the PDU Session.

If the serving AMF is changed, the new AMF shall wait until step 18 is finished with all the SMFs associated with the UE. Otherwise, steps 19 to 22 can continue in parallel to this step.

Step 18. New AMF to N3IWF: N2 AMF Mobility Request( ).

If the AMF has changed and the old AMF has indicated an existing NGAP UE association towards a N3IWF, the new AMF creates an NGAP UE association towards the N3IWF to which the UE is connected. This automatically releases the existing NGAP UE association between the old AMF and the N3IWF

Step 19. N3IWF to new AMF: N2 AMF Mobility Response( ).

Step 20a. [Conditional] old AMF to (V-)PCF: AMF-Initiated UE Policy Association Termination.

If the old AMF previously initiated a UE Policy Association to the PCF, and the old AMF did not transfer the PCF ID(s) to the new AMF (e.g. new AMF is in different PLMN), the old AMF performs an AMF-initiated UE Policy Association Termination procedure, as defined in clause 4.16.13.1, to delete the association with the PCF. In addition, if the old AMF transferred the PCF ID(s) in the UE context but the new AMF informed in step 10 that the UE Policy Association information in the UE context will not be used then the old AMF performs an AMF-initiated UE Policy Association Termination procedure, as defined in clause 4.16.13.1, to delete the association with the PCF.

Step 21b. [Optional] The new AMF (as described herein) performs a UE Policy Association Establishment as defined in clause 4.16.11. For an Emergency Registration, this step is skipped.

As disclosed herein, the new AMF sends a Npcf_UEPolicyControl Create Request to PCF. PCF sends a Npcf_UEPolicyControl Create Response to the new AMF.

PCF triggers UE Configuration Update Procedure as defined in clause 4.2.4.3.

Step 21. New AMF to UE: Registration Accept (5G-GUTI, Registration Area, Mobility restrictions, PDU Session status, Allowed NSSAI, [Mapping Of Allowed NSSAI], [Configured NSSAI for the Serving PLMN], [Mapping Of Configured NSSAI], [rejected S-NSSAIs], Periodic Registration Update timer, LADN Information and accepted MICO mode, IMS Voice over PS session supported Indication, Emergency Service Support indicator, Accepted DRX parameters, Network support of Interworking without N26, Access Stratum Connection Establishment NSSAI Inclusion Mode, Network Slicing Subscription Change Indication, Operator-defined access category definitions, [URSP Indication]). The Allowed NSSAI for the Access Type for the UE is included in the N2 message carrying the Registration Accept message.

The AMF sends a Registration Accept message to the UE indicating that the Registration Request has been accepted. 5G-GUTI is included if the AMF allocates a new 5G-GUTI. If the UE is already in RM-REGISTERED state via another access in the same PLMN, the UE shall use the 5G-GUTI received in the Registration Accept for both registrations. If no 5G-GUTI is included in the Registration Accept, then the UE uses the 5G-GUTI assigned for the existing registration also for the new registration. If the AMF allocates a new Registration area, it shall send the Registration area to the UE via Registration Accept message. If there is no Registration area included in the Registration Accept message, the UE shall consider the old Registration Area as valid. Mobility Restrictions is included in case mobility restrictions applies for the UE and Registration Type is not Emergency Registration. The AMF indicates the established PDU Sessions to the UE in the PDU Session status. The UE removes locally any internal resources related to PDU Sessions that are not marked as established in the received PDU Session status. If the AMF invokes the Nsmf_PDUSession_UpdateSMContext procedure for UP activation of PDU Session(s) in step 18 and receives rejection from the SMF, then the AMF indicates to the UE the PDU Session ID and the cause why the User Plane resources were not activated. When the UE is connected to the two AMFs belonging to different PLMN via 3GPP access and non-3GPP access then the UE removes locally any internal resources related to the PDU Session of the current PLMN that are not marked as established in received PDU Session status. If the PDU Session status information was in the Registration Request, the AMF shall indicate the PDU Session status to the UE. The Mapping Of Allowed NSSAI is the mapping of each S-NSSAI of the Allowed NSSAI to the HPLMN S-NSSAIs. The Mapping Of Configured NSSAI is the mapping of each S-NSSAI of the Configured NSSAI for the Serving PLMN to the HPLMN S-NSSAIs. The AMF shall include in the Registration Accept message the LADN Information for the list of LADNs, described in TS 23.501 [2] clause 5.6.5, that are available within the Registration area determined by the AMF for the UE. If the UE included MICO mode in the request, then AMF responds whether MICO mode should be used. The AMF may include Operator-defined access category definitions to let the UE determine the applicable Operator-specific access category definitions as described in TS 24.501 [25].

In the case of registration over 3GPP access, the AMF sets the IMS Voice over PS session supported Indication as described in clause 5.16.3.2 of TS 23.501 [2]. In order to set the IMS Voice over PS session supported Indication the AMF may need to perform the UE Capability Match Request procedure in clause 4.2.8a to check the compatibility of the UE and NG-RAN radio capabilities related to IMS Voice over PS. If the AMF hasn't received Voice Support Match Indicator from the NG-RAN on time then, based on implementation, AMF may set IMS Voice over PS session supported Indication and update it at a later stage.

In the case of registration over non-3GPP access, the AMF sets the IMS Voice over PS session supported Indication as described in clause 5.16.3.2a of TS 23.501 [2].

The Emergency Service Support indicator informs the UE that emergency services are supported, i.e. the UE is allowed to request PDU Session for emergency services. If the AMF received “MPS priority” from the UDM as part of Access and Mobility Subscription data, based on operator policy, “MPS priority” is included in the Registration Accept message to the UE to inform the UE whether configuration of Access Identity 1 is valid within the selected PLMN, as specified in TS 24.501 [25]. If the AMF received “MCX priority” from the UDM as part of Access and Mobility Subscription data, based on operator policy and UE subscription to MCX Services, “MCX priority” is included in the Registration Accept message to the UE to inform the UE whether configuration of Access Identity 2 is valid within the selected PLMN, as specified in TS 24.501 [25]. The Accepted DRX parameters are defined in clause 5.4.5 of TS 23.501 [2]. The AMF sets the Interworking without N26 parameter as described in clause 5.17.2.3.1 of TS 23.501 [2].

If the UDM intends to indicate the UE that subscription has changed, the Network Slicing Subscription Change Indication is included. If the AMF includes Network Slicing Subscription Change Indication, then the UE shall locally erase all the network slicing configuration for all PLMNs and, if applicable, update the configuration for the current PLMN based on any received information.

Additional information about the registration process is provided in 3GPP TS 23.502 V15.4.1 (2019-01), which is incorporated by reference herein.

The Access Stratum Connection Establishment NSSAI Inclusion Mode, as specified in TS 23.501 [2] clause 5.15.9, is included to instruct the UE on what NSSAI, if any, to include in the Access Stratum connection establishment. The AMF can set the value to modes of operation a,b,c defined in TS 23.501 [2] clause 5.15.9 in the 3GPP Access only if the Inclusion of NSSAI in RRC Connection Establishment Allowed indicates that it is allowed to do so. The 3GPP document TS 23.501 is incorporated by reference herein.

Step 22. [Conditional] UE to new AMF: Registration Complete( ).

The UE sends a Registration Complete message to the AMF when it has successfully updated itself after receiving any of the [Configured NSSAI for the Serving PLMN], [Mapping Of Configured NSSAI] and a Network Slicing Subscription Change Indication in step 21.

The UE sends a Registration Complete message to the AMF to acknowledge if a new 5G-GUTI was assigned.

If new 5G-GUTI was assigned, then the UE passes the new 5G-GUTI to its 3GPP access' lower layer when a lower layer (either 3GPP access or non-3GPP access) indicates to the UE's RM layer that the Registration Complete message has been successfully transferred across the radio interface.

NOTE 8: The above is needed because the NG-RAN may use the RRC Inactive state and a part of the 5G-GUTI is used to calculate the Paging Frame (see TS 38.304 [44] and TS 36.304 [43]). It is assumed that the Registration Complete is reliably delivered to the AMF after the 5G-AN has acknowledged its receipt to the UE.

When the List Of PDU Sessions To Be Activated is not included in the Registration Request and the Registration procedure was not initiated in CM-CONNECTED state, the AMF releases the signalling connection with UE, according to clause 4.2.6.

When the Follow-on request is included in the Registration Request, the AMF should not release the signalling connection after the completion of the Registration procedure.

If the AMF is aware that some signalling is pending in the AMF or between the UE and the 5GC, the AMF should not release the signalling connection immediately after the completion of the Registration procedure.

Step 23a. For Registration over 3GPP Access, if the AMF does not release the signalling connection, the AMF sends the RRC Inactive Assistance Information to the NG-RAN.

For Registration over non-3GPP Access, if the UE is also in CM-CONNECTED state on 3GPP access, the AMF sends the RRC Inactive Assistance Information to the NG-RAN.

Step 23. [Conditional] AMF to UDM: If the Access and Mobility Subscription data provided by UDM to AMF in 14b includes Steering of Roaming information with an indication that the UDM requests an acknowledgement of the reception of this information from the UE, the AMF provides the UE acknowledgement to UDM using Nudm_SDM_Info. For more details regarding the handling of Steering of Roaming information refer to TS 23.122 [22].

The AMF also uses the Nudm_SDM_Info service operation to provide an acknowledgment to UDM that the UE received the Network Slicing Subscription Change Indication (see step 21 and step 22) and acted upon it.

Step 24. [Conditional] AMF to UDM: After step 14a, and in parallel to any of the preceding steps, the AMF shall send a “Homogeneous Support of IMS Voice over PS Sessions” indication to the UDM using Nudm_UECM_Update:

If the AMF has evaluated the support of IMS Voice over PS Sessions, see clause 5.16.3.2 of TS 23.501 [2], and

If the AMF determines that it needs to update the Homogeneous Support of IMS Voice over PS Sessions, see clause 5.16.3.3 of TS 23.501 [2].

The mobility related event notifications towards the NF consumers are triggered at the end of this procedure for cases as described in clause 4.15.4.

During the UE Registration with 5GC, irrespective of roaming or non-roaming, this patent document discloses changes to send the Registration Accept message to the UE after the execution of the operation of Session Management Policy Association between the UE's serving AMF and the UE's serving PCF in the home PLMN. The Session Management Policy Association operation is to alert the UE's serving AMF for the session management policy information update from the UE's serving PCF in the home PLMN to the UE, if any. The session management policy information update includes the URSP rules. When the UE's serving AMF receives such alert from the UE's serving PCF in the home PLMN, the UE's serving AMF will then include the URSP Indication in the Registration Accept to the UE.

Once the UE receives that URSP Indication in the Registration Accept, the UE will then wait for the UE Configuration Update from the UE's serving PCF in the home PLMN before initiating any new establishment of SA or MA PDU session.

As the second option, as soon as the UE's serving PCF in the home PLMN, the UE's serving PCF in the home PLMN alerts the UE's serving AMF for the upcoming session management policy information update, the expectation is that, the UE's serving PCF in the home PLMN will trigger the UE Configuration Update Procedure soon. Hence, the UE may receive the UE Configuration Update before it initiates the SA or MA PDU session. This option is less deterministic to the UE because it will not receive any indication in advance for the upcoming UE Configuration Update.

As further described below, an example embodiment is to modify the existing procedures in clause 4.2.2.2.2 and in clause 4.16.11 of 3GPP Technical Specification TS 23.502. The solution applies to both non-roaming and roaming scenarios.

Example modification, which can be embodied as a change to the existing UE Registration Procedure as specified in clause 4.2.2.2.2 in 3GPP TS 23.502

The first change proposed by this patent document is to modify the UE Registration Procedures in clause 4.2.2.2.2 of TS 23.502 which is the general procedures for UE Registration with 5GC (shown in the above description of various steps of the registration process). In today UE registration procedure with 5GC, step 21 which is for the UE's serving AMF to send the Registration Accept to the UE to confirm the acceptance of the UE Registration Request and this step happens before Step 21b.

Step 21b is for the operation that UE's serving AMF initiates the establishment of the Policy Association (i.e. Npcf_UEPolicyControl Create Request) on behalf of the UE with the UE's serving PCF in order to enable the session management related policy information transfer via the UE Configuration Update Procedure which is an independent operation. For the response to the request from the UE's serving AMF for Policy Association Establishment (i.e. Npcf_UEPolicyControl Create Response), the UE's serving PCF provides the Policy Control Request Trigger parameter in the response to initiate the policy control trigger to the UE's serving AMF.

This patent document proposes, in some embodiments, to reverse the execution order between Step 21b

and Step 21. As a result, in Step 21, when UE's serving AMF receives such response (i.e. Npcf_UEPolicyControl Create Response) in Step 21b, the AMF would anticipate that the UE Configuration Update procedure will be triggered by UE's serving PCF in home PLMN to provide the URSP rules to the UE. As a result, the UE's serving AMF will include the URSP Indication in the Registration Accept message to notify the UE for the upcoming UE Configuration Update with URSP rules so that the UE could wait for such update before initiating any SA or MA PDU session. This approach is referred as solution option-1.

In addition to reverse the Step 21 and Step 21b as proposed herein, there are two possible options to modify Step 21. The two options are described below:

As solution option-2 described herein, only the revise order of the Step 21 and Step 21b as described above is implemented. Such change may be sufficient without introducing the URSP Indication in the UE Registration Accept message. The reverse of these two steps may allow the UE's serving PCF in the home PLMN to able to send the UE Configuration Update with the URSP rules to the UE before the UE initiates new SA or MA PDU session. However, this solution is lesser deterministic to the UE.

If solution option-1 is executed, Step 21 in clause 4.2.2.2.2 of 3GPP TS 23.502 is required to be modified so that it will include URSP Indication in the Registration Accept message to be sent to the UE.

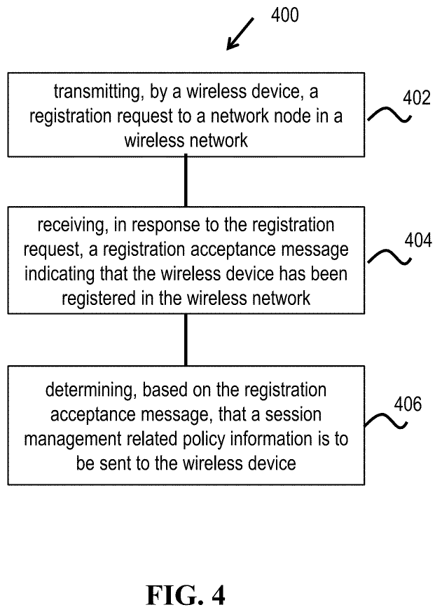

The following described the delta changes to Step 21 which are shown in red bold text, as well as the revised control flow for FIG. 4.2.2.2.2-1 of 3GPP TS 23.502 with the reverse order of Step 21 and Step 21b which is also shown with reference to FIG. 1B. Note that, no new text introduced to Step 21b except that the entire Step 21b is now to be executed before the Step 21 as proposed herein—i.e. the execution order of Step 21 and Step 21b is reversed. The changes to Step 21 as shown in red bold text below are only applicable for solution option-1 as described above.

START of proposed changes from this patent document to the excerpt from clause 4.2.2.2.2 of 3GPP TS 23.502 for Step 21 and Step 21b

(delimiter line)

21b. [Optional] The new AMF performs a UE Policy Association Establishment as defined in clause 4.16.11. For an Emergency Registration, this step is skipped.

The new AMF sends a Npcf_UEPolicyControl Create Request to PCF. PCF sends a Npcf_UEPolicyControl Create Response to the new AMF.

21. New AMF to UE: Registration Accept (5G-GUTI, Registration Area, Mobility restrictions, PDU Session status, Allowed NSSAI, [Mapping Of Allowed NSSAI], [Configured NSSAI for the Serving PLMN], [Mapping Of Configured NSSAI], [rejected S-NSSAIs], Periodic Registration Update timer, LADN Information and accepted MICO mode, IMS Voice over PS session supported Indication, Emergency Service Support indicator, Accepted DRX parameters, Network support of Interworking without N26, Access Stratum Connection Establishment NSSAI Inclusion Mode, Network Slicing Subscription Change Indication, Operator-defined access category definitions, URSP Indication). The Allowed NSSAI for the Access Type for the UE is included in the N2 message carrying the Registration Accept message.

The AMF sends a Registration Accept message to the UE indicating that the Registration Request has been accepted. 5G-GUTI is included if the AMF allocates a new 5G-GUTI. If the UE is already in RM-REGISTERED state via another access in the same PLMN, the UE shall use the 5G-GUTI received in the Registration Accept for both registrations. If no 5G-GUTI is included in the Registration Accept, then the UE uses the 5G-GUTI assigned for the existing registration also for the new registration. If the AMF allocates a new Registration area, it shall send the Registration area to the UE via Registration Accept message. If there is no Registration area included in the Registration Accept message, the UE shall consider the old Registration Area as valid. Mobility Restrictions is included in case mobility restrictions applies for the UE and Registration Type is not Emergency Registration. The AMF indicates the established PDU Sessions to the UE in the PDU Session status. The UE removes locally any internal resources related to PDU Sessions that are not marked as established in the received PDU Session status. If the AMF invokes the Nsmf_PDUSession_UpdateSMContext procedure for UP activation of PDU Session(s) in step 18 and receives rejection from the SMF, then the AMF indicates to the UE the PDU Session ID and the cause why the User Plane resources were not activated. When the UE is connected to the two AMFs belonging to different PLMN via 3GPP access and non-3GPP access then the UE removes locally any internal resources related to the PDU Session of the current PLMN that are not marked as established in received PDU Session status. If the PDU Session status information was in the Registration Request, the AMF shall indicate the PDU Session status to the UE. The Mapping Of Allowed NSSAI is the mapping of each S-NSSAI of the Allowed NSSAI to the HPLMN S-NSSAIs. The Mapping Of Configured NSSAI is the mapping of each S-NSSAI of the Configured NSSAI for the Serving PLMN to the HPLMN S-NSSAIs. The AMF shall include in the Registration Accept message the LADN Information for the list of LADNs, described in TS 23.501 [2] clause 5.6.5, that are available within the Registration area determined by the AMF for the UE. If the UE included MICO mode in the request, then AMF responds whether MICO mode should be used. The AMF may include Operator-defined access category definitions to let the UE determine the applicable Operator-specific access category definitions as described in TS 24.501 [25].

In the case of registration over 3GPP access, the AMF sets the IMS Voice over PS session supported Indication as described in clause 5.16.3.2 of TS 23.501 [2]. In order to set the IMS Voice over PS session supported Indication the AMF may need to perform the UE Capability Match Request procedure in clause 4.2.8a to check the compatibility of the UE and NG-RAN radio capabilities related to IMS Voice over PS. If the AMF hasn't received Voice Support Match Indicator from the NG-RAN on time then, based on implementation, AMF may set IMS Voice over PS session supported Indication and update it at a later stage.

In the case of registration over non-3GPP access, the AMF sets the IMS Voice over PS session supported Indication as described in clause 5.16.3.2a of TS 23.501 [2].

The Emergency Service Support indicator informs the UE that emergency services are supported, i.e. the UE is allowed to request PDU Session for emergency services. If the AMF received “MPS priority” from the UDM as part of Access and Mobility Subscription data, based on operator policy, “MPS priority” is included in the Registration Accept message to the UE to inform the UE whether configuration of Access Identity 1 is valid within the selected PLMN, as specified in TS 24.501 [25]. If the AMF received “MCX priority” from the UDM as part of Access and Mobility Subscription data, based on operator policy and UE subscription to MCX Services, “MCX priority” is included in the Registration Accept message to the UE to inform the UE whether configuration of Access Identity 2 is valid within the selected PLMN, as specified in TS 24.501 [25]. The Accepted DRX parameters are defined in clause 5.4.5 of TS 23.501 [2]. The AMF sets the Interworking without N26 parameter as described in clause 5.17.2.3.1 of TS 23.501 [2].

If the UDM intends to indicate the UE that subscription has changed, the Network Slicing Subscription Change Indication is included. If the AMF includes Network Slicing Subscription Change Indication, then the UE shall locally erase all the network slicing configuration for all PLMNs and, if applicable, update the configuration for the current PLMN based on any received information.

The Access Stratum Connection Establishment NSSAI Inclusion Mode, as specified in TS 23.501 [2] clause 5.15.9, is included to instruct the UE on what NSSAI, if any, to include in the Access Stratum connection establishment. The AMF can set the value to modes of operation a,b,c defined in TS 23.501 [2] clause 5.15.9 in the 3GPP Access only if the Inclusion of NSSAI in RRC Connection Establishment Allowed indicates that it is allowed to do so.

If AMF receives Policy Control Request Trigger parameters in the Npcf_UEPolicyControl Create Response, AMF includes the URSP Indication in the Registration Access message to indicate to the UE for the upcoming UE Configuration Update with new URSP rules. UE should wait for such update before initiating any new PDU session.

The next two paragraphs show text that can be cancelled from the current 3GPP specification 23.502.

21b. [Optional] The new AMF performs a UE Policy Association Establishment as defined in clause 4.16.11. For an Emergency Registration, this step is skipped.

The new AMF sends a Npcf_UEPolicyControl Create Request to PCF. PCF sends a Npcf_UEPolicyControl Create Response to the new AMF.

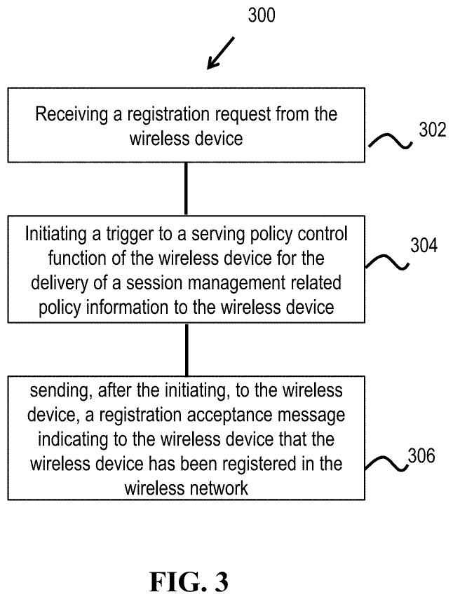

FIG. 3 is a flowchart for an example method 300 of wireless communication. The method 300 includes, at 302, receiving, by a device in a wireless network, a registration request from the wireless device. The method 300 includes, at 304, initiating, in response to the registration request, a trigger to a serving policy control function of the wireless device for the delivery of a session management related policy information to the wireless device by the serving policy control function of the wireless device. The method 300 includes, at 306, sending, after the initiating, to the wireless device, a registration acceptance message indicating to the wireless device that the wireless device has been registered in the wireless network.

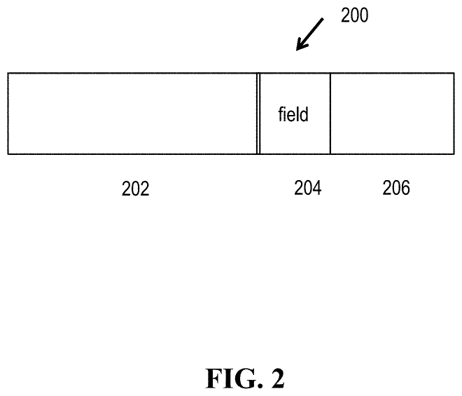

In some embodiments, the registration acceptance message may include a field indicating to the wireless device to expect the delivery of the session management related policy information by the serving policy control function of the wireless device. FIG. 2 shows an example format of the registration acceptance message in which the field 204 is shown in middle of the message, between a first portion 202 and a second portion 206. Alternatively, the field may be a syntax element that is at a beginning or an end of the registration acceptance message. Option 2 discussed above shows an example of such a message.

In some embodiments, the registration acceptance message excludes an explicit field indicating to the wireless device to expect the delivery of the session management related policy information. In other words, as described with respect to Option 1, the sequencing of the messages may implicitly indicate to the wireless device that session management related policy information will be sent to the wireless device by the serving policy control function of the wireless device.

In some embodiments, the session management related policy information is from a serving policy control function of the wireless device's serving home public land mobile network (PLMN). In case that the wireless device is roaming in a visited network, the session management related policy information is from the serving policy control function of the home PLMN of the wireless device.

FIG. 4 is a flowchart for a method 400 of wireless communication implemented at a wireless device such as a UE. The method 400 includes, at 402, transmitting, by a wireless device, a registration request to a network node in a wireless network. The method 400 includes, at 404, receiving, in response to the registration request, a registration acceptance message indicating that the wireless device has been registered in the wireless network. The method 400 includes, at 406, determining, based on the registration acceptance message, that a session management related policy information is to be sent to the wireless device by the serving policy control function of the wireless device. Additional features associated with the method 400 are described with reference to the method 300.

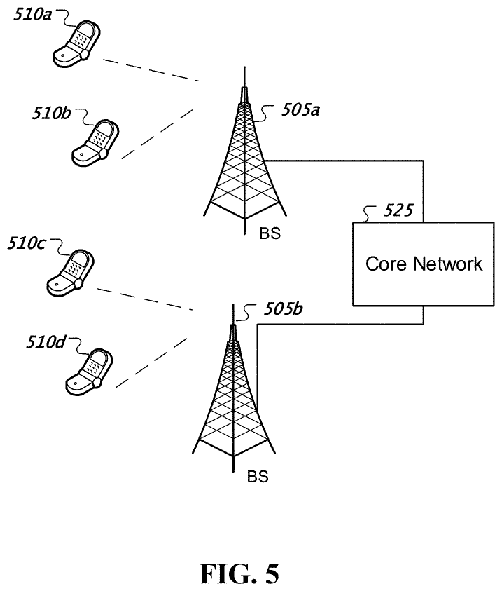

FIG. 5 shows an example of a wireless communication system 500 where techniques in accordance with one or more embodiments of the present technology can be applied. A wireless communication system 500 can include one or more base stations (BSs) 505a, 505b, one or more wireless devices 510a, 510b, 510c, 510d, and a core network 525. A base station 505a, 505b can provide wireless service to wireless devices 510a, 510b, 510c and 510d in one or more wireless sectors. In some implementations, a base station 505a, 505b includes directional antennas to produce two or more directional beams to provide wireless coverage in different sectors.

The core network 525 can communicate with one or more base stations 505a, 505b. The core network 525 provides connectivity with other wireless communication systems and wired communication systems. The core network may include one or more service subscription databases to store information related to the subscribed wireless devices 510a, 510b, 510c, and 510d. A first base station 505a can provide wireless service based on a first radio access technology, whereas a second base station 505b can provide wireless service based on a second radio access technology. The base stations 505a and 505b may be co-located or may be separately installed in the field according to the deployment scenario. The wireless devices 510a, 510b, 510c, and 510d can support multiple different radio access technologies.

In some implementations, a wireless communication system can include multiple networks using different wireless technologies. A dual-mode or multi-mode wireless device includes two or more wireless technologies that could be used to connect to different wireless networks.

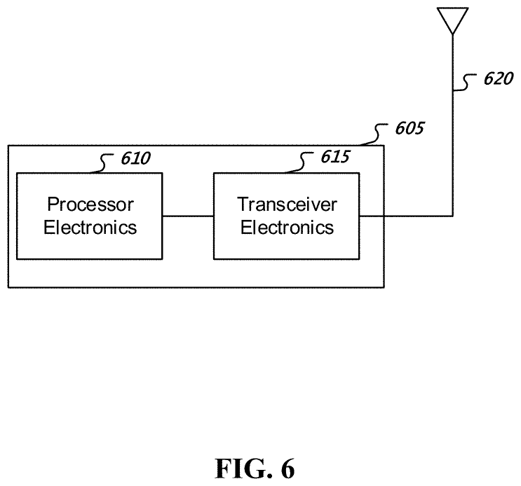

FIG. 6 is a block diagram representation of a portion of a radio station. A radio station 605 such as the network-side device or a wireless terminal or a UE can include processor electronics 610 such as a microprocessor that implements one or more of the wireless techniques presented in this document. The radio station 605 can include transceiver electronics 615 to send and/or receive wireless signals over one or more communication interfaces such as antenna 620. The radio station 605 can include other communication interfaces for transmitting and receiving data. Radio station 605 can include one or more memories (not explicitly shown) configured to store information such as data and/or instructions. In some implementations, the processor electronics 610 can include at least a portion of the transceiver electronics 615. In some embodiments, at least some of the disclosed techniques, modules or functions are implemented using the radio station 605. The radio station 605 may for example be used as a hardware platform to implement a method described in the present document.

In some embodiments, a computer readable medium may be used to store processor-executable instructions for implementing a method described in the present document.

It will be appreciated that the present document discloses techniques for streamlining registration process for a UE by providing an indication of session management related policy to be sent to the UE.

It will further be appreciated that different options are possible for implementation of such signaling. An explicit option in which a field indicates to the UE that a session management related policy information is imminent. Alternatively, an implicit indication may be provided based on an order of message exchange in which the independent signaling to deliver the session management policy information would have been triggered before the registration acceptance is sent to the wireless device as described in the present document.

The disclosed and other embodiments, modules and the functional operations described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described and other implementations, enhancements and variations can be made based on what is described and illustrated in this patent document.

What is claimed is:

1. A method of wireless communication, comprising:
receiving, by a device in a wireless network, a registration request from the wireless device;
initiating, in response to the registration request, a trigger to a serving policy control function of the wireless device for the delivery of a session management related policy information to the wireless device by the serving policy control function of the wireless device; and
sending, after the initiating, to the wireless device, a registration acceptance message indicating to the wireless device that the wireless device has been registered in the wireless network.

2. The method of claim 1, wherein the registration acceptance message includes a field indicating to the wireless device to expect the delivery of the session management related policy information from the serving policy control function of the wireless device.

3. The method of claim 1, wherein the registration acceptance message excludes an explicit field indicating to the wireless device to expect the delivery of the session management related policy information from the serving policy control function of the wireless device.

4. The method of claim 1, wherein the delivery of the session management related policy information is from a serving policy control function of the wireless device.

5. The method of claim 1, wherein the wireless network is operating using a third generation partnership project (3GPP) protocol.

6. The method of claim 1, wherein the wireless network is operating using non-3GPP protocol.

7. The method of claim 4, wherein the wireless device is in a roaming mode, and the wireless network is a visited network of the wireless device, and wherein the serving policy control function is from a home public land mobile network of the wireless device.

8. The method of claim 4, wherein the wireless device is in a non-roaming mode, and wherein the serving policy control function is of a serving public land mobile network of the wireless device.

9. A method of wireless communication, comprising:
transmitting, by a wireless device, a registration request to a network node in a wireless network;
receiving, in response to the registration request, a registration acceptance message indicating that the wireless device has been registered in the wireless network; and
determining, based on the registration acceptance message, that a session management related policy information is to be sent to the wireless device by a serving policy control function of the wireless device.

10. The method of claim 9, wherein the registration acceptance message includes a field that indicates that the session management related policy information is to be sent to the wireless device by the serving policy control function of the wireless device.

11. The method of claim 9, wherein the delivery of the session management related policy information is from a serving policy control function of the wireless device.

12. The method of claim 9, wherein the wireless network is operating using a third generation partnership project (3GPP) protocol.

13. The method of claim 9, wherein the wireless network is operating using non-3GPP protocol.

14. The method of claim 11, wherein the wireless device is in a roaming mode, and the wireless network is a visited network of the wireless device, and wherein the serving policy control function is from a home public land mobile network of the wireless device.

15. The method of claim 11, wherein the wireless device is in a non-roaming mode, and the serving policy control function is of a serving public land mobile network of the wireless device

16. A hardware platform comprising a processor configured to implement a method comprising:
receiving, by a device in a wireless network, a registration request from the wireless device;
initiating, in response to the registration request, a trigger to a serving policy control function of the wireless device for the delivery of a session management related policy information to the wireless device by the serving policy control function of the wireless device; and
sending, after the initiating, to the wireless device, a registration acceptance message indicating to the wireless device that the wireless device has been registered in the wireless network.

17. The method of claim 16, wherein the registration acceptance message includes a field indicating to the wireless device to expect the delivery of the session management related policy information from the serving policy control function of the wireless device.

18. The method of claim 16, wherein the registration acceptance message excludes an explicit field indicating to the wireless device to expect the delivery of the session management related policy information from the serving policy control function of the wireless device.

19. The method of claim 16, wherein the delivery of the session management related policy information is from a serving policy control function of the wireless device.

20. The method of claim 16, wherein the wireless network is operating using a third generation partnership project (3GPP) protocol.

21. The method of claim 16, wherein the wireless network is operating using non-3GPP protocol.

22. The method of claim 19, wherein the wireless device is in a roaming mode, and the wireless network is a visited network of the wireless device, and wherein the serving policy control function is from a home public land mobile network of the wireless device.

23. The method of claim 19, wherein the wireless device is in a non-roaming mode, and wherein the serving policy control function is of a serving public land mobile network of the wireless device.

24. A method of wireless communication, comprising:
transmitting, by a wireless device, a registration request to a network node in a wireless network;
receiving, in response to the registration request, a registration acceptance message indicating that the wireless device has been registered in the wireless network; and
determining, based on the registration acceptance message, that a session management related policy information is to be sent to the wireless device by a serving policy control function of the wireless device.

25. The method of claim 24, wherein the registration acceptance message includes a field that indicates that the session management related policy information is to be sent to the wireless device by the serving policy control function of the wireless device.

26. The method of claim 24, wherein the delivery of the session management related policy information is from a serving policy control function of the wireless device.

27. The method of claim 24, wherein the wireless network is operating using a third generation partnership project (3GPP) protocol.

28. The method of claim 24, wherein the wireless network is operating using non-3GPP protocol.

29. The method of claim 26, wherein the wireless device is in a roaming mode, and the wireless network is a visited network of the wireless device, and wherein the serving policy control function is from a home public land mobile network of the wireless device.

30. The method of claim 26, wherein the wireless device is in a non-roaming mode, and the serving policy control function is of a serving public land mobile network of the wireless device.
